(19) United States
(12) Patent Application Publication
(10) Pub. No.: US 2025/0127323 A1
(43) Pub. Date: Apr. 24, 2025

(54) POUR OVER DRIPPER

(71) Applicants: Michael W. Taylor, Williamstown, MA (US); Warren Taylor, Williamstown, MA (US)

(72) Inventors: Michael W. Taylor, Williamstown, MA (US); Warren Taylor, Williamstown, MA (US)

(21) Appl. No.: 18/917,114

(22) Filed: Oct. 16, 2024

Related U.S. Application Data
(60) Provisional application No. 63/544,663, filed on Oct. 18, 2023.

(51) Int. Cl. A47J 31/02

(52) U.S. Cl. CPC A47J 31/02

(57) ABSTRACT

A pour over dripper including an outer shell having a shell wall with an upper rim and a shell base wall opposite the upper rim; an inert funnel insert connected with the outer shell, the funnel insert having a flange portion in operative communication with the upper rim, the funnel insert having a lower section in operative communication with a base wall aperture; and a chamber formed between the shell wall and the funnel insert, wherein the chamber is configured to insulate between the funnel insert and the shell wall.

### CROSS-REFERENCE TO RELATED APPLICATION

This application claims the benefit of U.S. Provisional Patent Application No. 63/544,663 filed Oct. 18, 2023 entitled POUR OVER DRIPPER, the disclosure of which is incorporated by reference in its entirety.

### BACKGROUND

The present disclosure is directed to an improved pour over dripper device.

Coffee drinks are popular beverages enjoyed in various parts of the world, hot or cold. Coffee drinks have a wide range of taste and flavors depending on factors such as origin and type of coffee beans, roasting technique used, and the brewing method used. Each of these factors can have a significant impact on the flavor and aroma of the resulting coffee drink. For example, even using beans from one batch, using different brewing methods can produce coffee drinks that taste very different.

Pour over coffee drippers for manually preparing filtered coffee are known. The dripper typically includes a filter and a frame to hold the filter over a glass, mug, cup, vacuum flask or carafe. The filter may be a reusable stainless steel/plastic filter/ceramic and/or may require a paper filter. Ground coffee is manually inserted into the filter prior to use. While preparing coffee, it is generally advised to pour preheated water over the coffee, let the water drip through the filter, pause and then repeat until all the water for preparing the coffee is used up. A dedicated vessel with a long thin spout is typically used to pour the preheated water over the coffee to assist in manually controlling the rate of the pouring. In this manner, the preheated water passes through the grounded coffee without accumulating in the filter. This gradual pouring process provides properly extracting the rich flavor of the coffee while avoiding over brewing.

The dripper offers the advantage of allowing one or more cup of coffee to be made at a time, in addition to ease of cleaning that comes with simplicity of design.

While there are several different coffee drippers on the market today made with different designs and materials, each product has its disadvantage. A dripper that will allow optimal extraction for improved flavor and aroma in the resulting drink is desired.

### SUMMARY

In accordance with the present disclosure, there is provided a pour over dripper comprising an outer shell having a shell wall with an upper rim and a shell base wall opposite the upper rim; a funnel insert removably connected with the outer shell, the funnel insert having a flange portion in operative communication with the upper rim, the funnel insert having a lower section in operative communication with a base wall aperture; and a chamber formed between the shell wall and the funnel insert, wherein the chamber is configured to insulate between the funnel insert and the shell wall.

A further embodiment of any of the foregoing embodiments may additionally and/or alternatively include the shell wall comprises a shell wall exterior opposite a shell wall interior; the shell wall comprises exterior ribs, the exterior ribs extend along the shell wall exterior from the upper rim to the shell base wall.

A further embodiment of any of the foregoing embodiments may additionally and/or alternatively include the flange portion comprises a perimeter that defines a funnel inlet of the funnel insert.

A further embodiment of any of the foregoing embodiments may additionally and/or alternatively include the funnel insert comprises a midsection defined by a funnel wall formed between the flange portion and the lower section; the midsection comprises a frustoconical tapered shape in the funnel wall; the tapered shape extends from the flange portion at a first diameter to a second diameter proximate the lower section.

A further embodiment of any of the foregoing embodiments may additionally and/or alternatively include the lower section comprises a lower portion cylinder that extends to a discharge plate; the lower portion cylinder extends through the base wall aperture.

A further embodiment of any of the foregoing embodiments may additionally and/or alternatively include the discharge plate comprises a discharge hole pattern, the discharge hole pattern configured with a predetermined cross-sectional area of discharge holes formed in the discharge plate.

A further embodiment of any of the foregoing embodiments may additionally and/or alternatively include the discharge plate comprises a boss extending from the discharge plate.

In accordance with the present disclosure, there is provided a pour over dripper comprising an outer shell having a shell wall with an upper rim and a shell base wall opposite the upper rim; a funnel insert removably connected with the outer shell, the funnel insert having a flange portion in operative communication with the upper rim, the funnel insert having a lower section in operative communication with a base wall aperture; wherein the funnel insert comprises a midsection defined by a funnel wall formed between the flange portion and the lower section; the midsection comprises a frustoconical tapered shape in the funnel wall; the tapered shape extends from the flange portion at a first diameter to a second diameter proximate the lower section; wherein the lower section comprises a lower portion cylinder that extends to a discharge plate; the lower section extends through the base wall aperture; the discharge plate comprises a discharge hole pattern, the discharge hole pattern configured with a predetermined cross-sectional area of discharge holes formed in the discharge plate.

A further embodiment of any of the foregoing embodiments may additionally and/or alternatively include the flange portion comprises a perimeter that defines a funnel inlet of the funnel insert.

A further embodiment of any of the foregoing embodiments may additionally and/or alternatively include the discharge plate comprises at least one boss formed by extrusion of the discharge plate outwardly away from the lower section; the at least one boss configured to elevate the discharge plate from a surface.

A further embodiment of any of the foregoing embodiments may additionally and/or alternatively include the funnel insert comprises a stainless steel alloy material.

A further embodiment of any of the foregoing embodiments may additionally and/or alternatively include the pour over dripper further comprising a chamber formed between the shell wall and the funnel insert, wherein the chamber is configured to insulate between the funnel insert and the shell wall.

A further embodiment of any of the foregoing embodiments may additionally and/or alternatively include the pour over dripper further comprising a chamber formed between the shell wall and the funnel insert, wherein the chamber is configured to insulate between the funnel insert and the shell wall.

A further embodiment of any of the foregoing embodiments may additionally and/or alternatively include the exterior ribs comprise a non-slip grip pattern on the exterior of the outer shell.

In accordance with the present disclosure, there is provided a process for making a pour over dripper comprising forming an outer shell having a shell wall with an upper rim and a shell base wall opposite the upper rim; forming a funnel insert comprising an inert material removably connected with the outer shell, the funnel insert having a flange portion in operative communication with the upper rim, the funnel insert having a lower section in operative communication with a base wall aperture; and forming a chamber between the shell wall and the funnel insert, wherein the chamber is configured to insulate between the funnel insert and the shell wall.

A further embodiment of any of the foregoing embodiments may additionally and/or alternatively include the shell wall comprises a shell wall exterior opposite a shell wall interior; and forming exterior ribs, along a portion of the shell wall exterior between the upper rim and the shell base wall.

A further embodiment of any of the foregoing embodiments may additionally and/or alternatively include the process further comprising forming a midsection defined by a funnel wall formed between the flange portion and the lower section; the midsection comprises a frustoconical tapered shape in the funnel wall; the tapered shape extends from the flange portion at a first diameter to a second diameter proximate the lower section.

A further embodiment of any of the foregoing embodiments may additionally and/or alternatively include the process further comprising forming a lower portion cylinder in the lower section that extends to a discharge plate; the lower portion cylinder extends through the base wall aperture.

A further embodiment of any of the foregoing embodiments may additionally and/or alternatively include the process further comprising forming a discharge hole pattern in the discharge plate, the discharge hole pattern configured with a predetermined cross-sectional area of discharge holes formed in the discharge plate.

A further embodiment of any of the foregoing embodiments may additionally and/or alternatively include the inert material comprises a stainless steel alloy.

A further embodiment of any of the foregoing embodiments may additionally and/or alternatively include the flange portion nests with the upper rim and the lower section nests in the base wall aperture.

Other details of the pour over dripper are set forth in the following detailed description and the accompanying drawings wherein like reference numerals depict like elements.

### BRIEF DESCRIPTION OF THE DRAWINGS

FIG. 1 is a top perspective view schematic representation of an exemplary pour over dripper.

FIG. 2 is a bottom perspective view schematic representation of an exemplary pour over dripper.

FIG. 3 is a cross-section schematic representation of an exemplary pour over dripper.

FIG. 4 is an isometric view schematic representation of an exemplary pour over dripper.

FIGS. 5A to 5G are multiple views of a schematic representation of an exemplary pour over dripper.

FIG. 6 a perspective view schematic representation of an exemplary pour over dripper in use.

### DETAILED DESCRIPTION

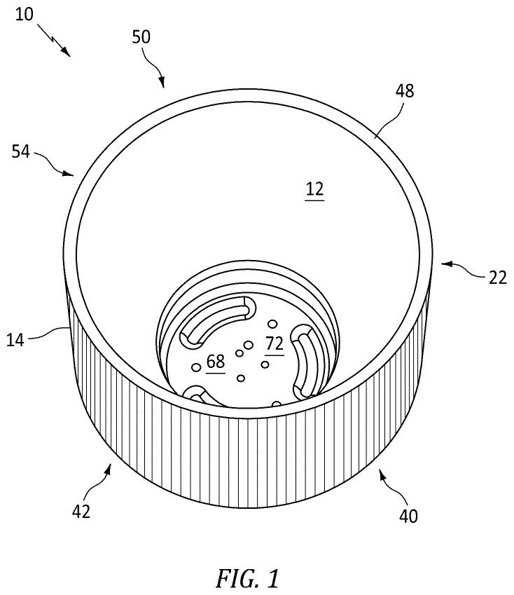

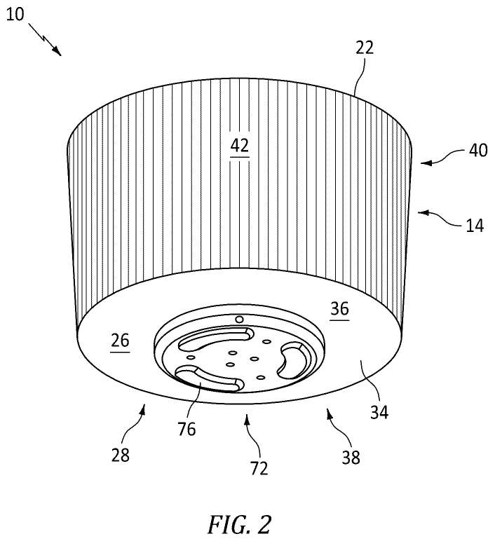

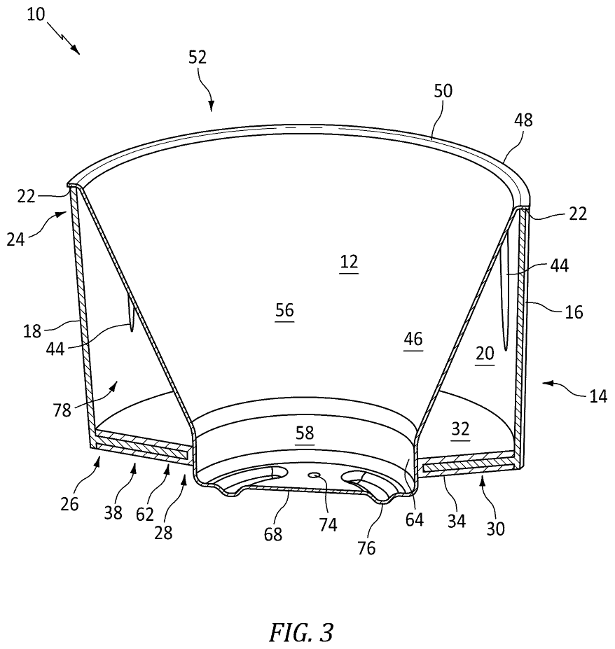

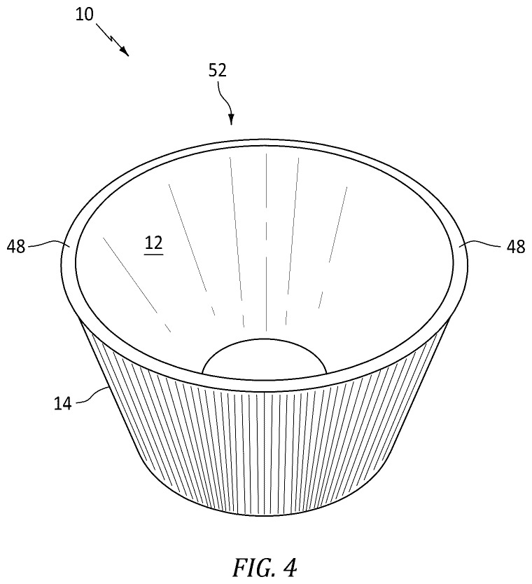

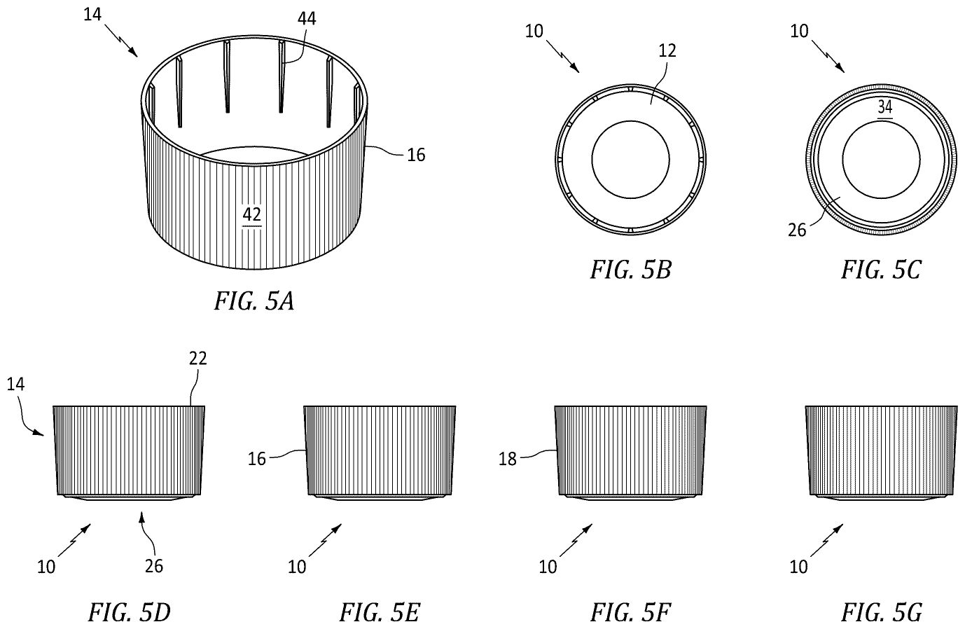

Referring now to FIG. 1 through FIG. 6, there is illustrated a pour over dripper 10. The pour over dripper 10 includes two main components a funnel insert 12 insertable within an outer shell 14.

The outer shell 14 includes a shell wall 16. The shell wall 16 is formed as a right circular cylinder. In other embodiments the shell wall 16 can have contours and taper. The shell wall 16 includes a shell wall exterior 18 opposite a shell wall interior 20. The shell wall 16 includes an upper rim 22. The upper rim 22 forms an outer shell wall receiver 24. The outer shell wall receiver 24 is configured to receive the funnel insert 12.

The outer shell 14 includes a shell base wall 28. The shell base wall 28 attaches to or extends from the shell wall 16 opposite the upper rim 22. The shell base wall 28 defines a base wall aperture 28. The base wall aperture 28 receives a portion of the funnel insert 12. The shell base wall 28 defines a base wall exterior 30 opposite a base wall interior 32. The shell base wall 26 includes a base wall bottom surface 34 on the base wall exterior 30. The base wall bottom surface 34 is configured with a non-slip composition 36 configured to provide friction traction to support the pour over dripper 10 and prevent unwanted movement in operation. The base wall bottom surface 34 can be a rubber composition or other material with similar properties. The base wall bottom surface 34 includes a base wall taper 38. The base wall taper 38 is configured to stabilize the pour over dripper 10. The base wall taper 38 inclines from the shell wall 16 toward the base wall aperture 28. The base wall taper 38 can be formed by changes in the thickness of the shell base wall 26 and/or by forming a concave shaped or convex shaped shell base wall 26.

The shell wall 16 includes exterior ribs 40. The exterior ribs 40 can extend along the shell wall exterior 18 from the upper rim 22 to the shell base wall 26. The exterior ribs 40 provide a non-slip grip pattern 42 on the exterior 18 of the outer shell 14. The non-slip grip pattern 42 is configured to provide the user with easy manipulation of the pour over dripper 10. The exterior ribs 40 are shown as generally parallel aligned ribs 40. It is contemplated that the exterior ribs 40 can be non-parallel, zig-zaged, serpentine, intermittent, and the like. The exterior ribs 40 can also be constructed from a tacky composition to provide tactile gripping properties.

Interior ribs 44 are formed along the shell wall interior 20. The interior ribs 44 can extend inwardly from the shell wall interior 20 in a direction opposite the shell wall exterior 18. The interior ribs 44 can be spaced apart around the shell wall interior 20. The interior ribs 44 can extend from the upper rim 22 toward the shell base wall 26. In exemplary embodiments the interior ribs 44 extend along the shell wall interior 20 a portion of the shell wall interior 20. The interior ribs 44 can function to stiffen the shell wall 16. The interior ribs 44 can stabilize the funnel insert 12.

The funnel insert 12 can be formed with a funnel wall 46. The funnel wall 46 includes a flange portion 48 that nests with the upper rim 22 of the outer shell 14. The flange portion 48 is shown as forming a perimeter 50 that defines the funnel mouth or inlet 52 of the funnel insert 12. The perimeter 50 can be sized by a first diameter 54 of the funnel insert 12. The inlet 52 is configured to receive a filter element, such as a coffee filter (not shown) insertable into the inlet 52 of the funnel insert 12. The funnel insert 12 includes a midsection 56 defined by the funnel wall 46 between the flange portion 48 and a lower section 58. The midsection 56 includes the frustoconical tapered shape 60 in the funnel wall 46. The tapered shape 60 extends from the flange portion 48 at a maximum first diameter 54 to a minimum second diameter 62 proximate the lower section 58.

The lower section 58 includes a lower portion cylinder 64 that extends to a discharge plate 68. The lower section 58 nests in the base wall aperture 28. The lower section 58 extends through the base wall aperture 28. The discharge plate 68 extends beyond the shell base wall 26. In the embodiment shown, the lower portion cylinder 64 includes the second diameter 62 which is sized to snugly fit through the base wall aperture 28. The funnel insert 12 can be inserted and removed from the outer shell 14. The flange portion 48 and lower section 58 are friction fit with the upper rim 22 and base wall aperture 28 respectively. In an alternative embodiment, the funnel insert 12 can be sealed with the outer shell 14 to be watertight.

The discharge plate 68 includes a precision discharge hole pattern 70. The discharge hole pattern 70 is configured with a predetermined cross-sectional area 72 of discharge holes 74. The discharge hole pattern 70 and cross-sectional area 72 of discharge holes 74 can provide for a precise drip rate for the water flowing through the coffee grounds (not shown). The discharge holes 74 can be formed in a circular shape, and any other shape that defines a predetermined flow area.

The discharge plate 68 includes a boss 76 extending from the discharge plate 68. The exemplary embodiment shown includes three bosses 76 formed by extrusion of the discharge plate 68 outwardly away from the lower section 58. The bosses 76 allow for the discharge plate 68 to be elevated from a surface such that liquid can drain through the discharge holes 74 so that the pour over dripper 10 can self-drain when placed on a flat surface after use. The boss 76 is shown shaped as a semicircular crescent shaped portion. It is contemplated that more or less bosses 76 can be employed.

The funnel insert 12 is composed of an inert non-reactive material, such as stainless steel alloy material. In a preferred embodiment the funnel insert comprises 304 stainless steel material. The stainless steel material is inert to the water and coffee materials and prevents reaction or contamination from contacting the funnel insert during use. Thus, there is less chance of materials leaching into the coffee drink from the funnel insert 12. The stainless steel funnel insert 12 is easier to clean and keep stain free.

A chamber 78 is formed between the shell wall 16 and the funnel insert 12. The chamber 78 is relatively air-tight and creates an insulating property between the funnel insert 12 and the shell wall 16. The chamber 78 enables the use of the stainless steel funnel insert 12, since the stainless steel material is conductive to thermal energy transferred from the hot water employed in the coffee brewing process. By having the chamber 78 and the thermal insulation the chamber 78 provides, the inert stainless steel can be utilized without the deleterious effects of the heat transfer making handling of the pour over dripper 10 easier without discomfort.

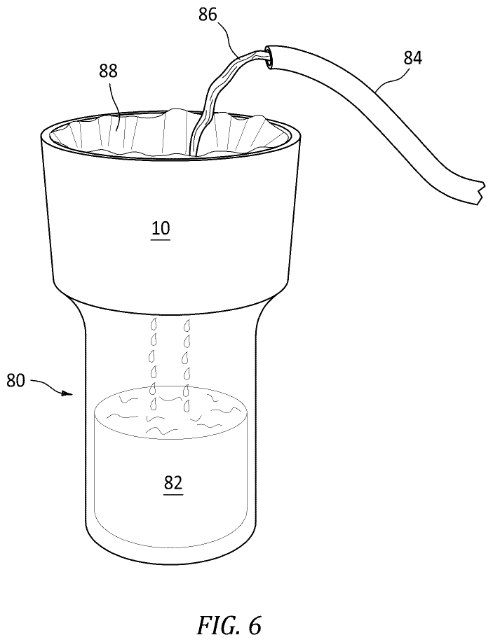

Referring also to FIG. 6, the pour over dripper 10 is shown in use. The pour over dripper 10 can be placed over a container 80 for use in preparing a beverage 82, such as water, coffee, tea and the like. A pour spout 84 is shown dispensing water 86 into a filter 88 placed in the pour over dripper 10. The water 86 passes over coffee grounds or tea leaves and the like, and through the discharge holes 74 into the container 80.

A technical advantage of the disclosed pour over dripper includes an insulated stainless steel funnel.

Another technical advantage of the disclosed pour over dripper includes a removable funnel insert for ease of cleaning and maintenance.

Another technical advantage of the disclosed pour over dripper includes a non-slip bottom surface configured to anchor the pour over dripper to a vessel.

Another technical advantage of the disclosed pour over dripper includes a ribbed outer shell that provides a non-slip grip pattern on the exterior of the outer shell.

Another technical advantage of the disclosed pour over dripper includes a precision hole pattern which creates a precise drip rate for ideal coffee extraction.

Another technical advantage of the disclosed pour over dripper includes a base wall bottom surface designed to sit flush on a vessel, such as a carafe.

Another technical advantage of the disclosed pour over dripper includes a boss pattern extruded from the stainless steel discharge plate providing a gap that allows for the funnel insert to completely self-drain when placed on a flat surface.

There has been provided a pour over dripper. While the pour over dripper has been described in the context of specific embodiments thereof, other unforeseen alternatives, modifications, and variations may become apparent to those skilled in the art having read the foregoing description. Accordingly, it is intended to embrace those alternatives, modifications, and variations which fall within the broad scope of the appended claims.

What is claimed is:

1. A pour over dripper comprising:
an outer shell having a shell wall with an upper rim and a shell base wall opposite the upper rim;
an inert funnel insert connected with the outer shell, the funnel insert having a flange portion in operative communication with the upper rim, the funnel insert having a lower section in operative communication with a base wall aperture; and
a chamber formed between the shell wall and the funnel insert, wherein the chamber is configured to insulate between the funnel insert and the shell wall.

2. The pour over dripper according to claim 1, wherein the shell wall comprises a shell wall exterior opposite a shell wall interior; the shell wall comprises exterior ribs, the exterior ribs extend along the shell wall exterior from the upper rim to the shell base wall.

3. The pour over dripper according to claim 2, wherein the flange portion comprises a perimeter that defines a funnel inlet of the funnel insert.

4. The pour over dripper according to claim 3, wherein the funnel insert comprises a midsection defined by a funnel wall formed between the flange portion and the lower section; the midsection comprises a frustoconical tapered shape in the funnel wall; the tapered shape extends from the flange portion at a first diameter to a second diameter proximate the lower section.

5. The pour over dripper according to claim 4, wherein the lower section comprises a lower portion cylinder that extends to a discharge plate; the lower portion cylinder extends through the base wall aperture.

6. The pour over dripper according to claim 5, wherein the discharge plate comprises a discharge hole pattern, the discharge hole pattern configured with a predetermined cross-sectional area of discharge holes formed in the discharge plate.

7. The pour over dripper according to claim 5, wherein the discharge plate comprises a boss extending from the discharge plate.

8. A pour over dripper comprising:
an outer shell having a shell wall with an upper rim and a shell base wall opposite the upper rim;
a funnel insert connected with the outer shell, the funnel insert having a flange portion in operative communication with the upper rim, the funnel insert having a lower section in operative communication with a base wall aperture; wherein the funnel insert comprises a midsection defined by a funnel wall formed between the flange portion and the lower section; the midsection comprises a frustoconical tapered shape in the funnel wall; the tapered shape extends from the flange portion at a first diameter to a second diameter proximate the lower section; wherein the lower section comprises a lower portion cylinder that extends to a discharge plate; the lower section extends through the base wall aperture; the discharge plate comprises a discharge hole pattern, the discharge hole pattern configured with a predetermined cross-sectional area of discharge holes formed in the discharge plate.

9. The pour over dripper according to claim 8, wherein the flange portion comprises a perimeter that defines a funnel inlet of the funnel insert.

10. The pour over dripper according to claim 8, wherein the discharge plate comprises at least one boss formed by extrusion of the discharge plate outwardly away from the lower section; the at least one boss configured to elevate the discharge plate from a surface.

11. The pour over dripper according to claim 8, wherein the funnel insert comprises a stainless steel alloy material.

12. The pour over dripper according to claim 8, further comprising:
a chamber formed between the shell wall and the funnel insert, wherein the chamber is configured to insulate between the funnel insert and the shell wall.

13. The pour over dripper according to claim 8, wherein the exterior ribs comprise a non-slip grip pattern on the exterior of the outer shell.

14. A process for making a pour over dripper comprising:
forming an outer shell having a shell wall with an upper rim and a shell base wall opposite the upper rim;
forming a funnel insert comprising an inert material connected with the outer shell, the funnel insert having a flange portion in operative communication with the upper rim, the funnel insert having a lower section in operative communication with a base wall aperture; and
forming a chamber between the shell wall and the funnel insert, wherein the chamber is configured to insulate between the funnel insert and the shell wall.

15. The process of claim 14, wherein the shell wall comprises a shell wall exterior opposite a shell wall interior;
forming exterior ribs, along a portion of the shell wall exterior between the upper rim and the shell base wall.

16. The process of claim 14, further comprising:
forming a midsection defined by a funnel wall formed between the flange portion and the lower section; the midsection comprises a frustoconical tapered shape in the funnel wall; the tapered shape extends from the flange portion at a first diameter to a second diameter proximate the lower section.

17. The process of claim 14, further comprising:
forming a lower portion cylinder in the lower section that extends to a discharge plate; the lower portion cylinder extends through the base wall aperture.

18. The process of claim 14, further comprising:
forming a discharge hole pattern in the discharge plate, the discharge hole pattern configured with a predetermined cross-sectional area of discharge holes formed in the discharge plate.

19. The process of claim 14, wherein the inert material comprises a stainless steel alloy.

20. The process of claim 14, wherein the flange portion nests with the upper rim and the lower section nests in the base wall aperture.
